(19) United States
(12) Patent Application Publication
(10) Pub. No.: US 2024/0339784 A1
(43) Pub. Date: Oct. 10, 2024

(54) CONNECTOR FITTING STRUCTURE

(71) Applicant: Yazaki Corporation, Tokyo (JP)

(72) Inventors: Seiji Kozono, Shizuoka (JP); Yoshitaka Tsushima, Shizuoka (JP); Masaya Okamoto, Shizuoka (JP)

(21) Appl. No.: 18/748,470

(22) Filed: Jun. 20, 2024

Related U.S. Application Data
(63) Continuation of application No. PCT/JP2023/005611, filed on Feb. 16, 2023.

(30) Foreign Application Priority Data
Feb. 28, 2022 (JP) 2022-029802

(51) Int. Cl. H01R 13/629; H01R 13/52

(52) U.S. Cl. CPC H01R 13/62977; H01R 13/5213

(57) ABSTRACT

A connector fitting structure of a first connector and a second connector that are to be fitted and electrically connected to each other is provided. The first connector includes: a first housing that accommodates a first connection terminal; and a guide groove that is provided in the first housing. The second connector includes: a second housing that accommodates a second connection terminal; a guide protrusion portion that is provided at the second housing and is inserted into the guide groove; and a guide protection portion configured to be displaced between a covered position where the guide protection portion covers the guide protrusion portion and an exposed position where the guide protection portion does not cover the guide protrusion portion.

### CROSS-REFERENCE TO RELATED APPLICATIONS

This is a continuation of International Application No. PCT/JP2023/005611 filed on Feb. 16, 2023, and claims priority from Japanese Patent Application No. 2022-029802 filed on Feb. 28, 2022, the entire content of which is incorporated herein by reference.

### TECHNICAL FIELD

The present invention relates to a connector fitting structure.

### BACKGROUND ART

In the related art, wire harnesses (electric wires) that electrically connect various electric components mounted on an automobile or the like are connected by connectors. In order to well fit such a connector, it is considered to apply, for example, a connector guide mechanism disclosed in Patent Literature 1.

The connector guide mechanism includes a plug, a socket, a plug side guide, and a socket side guide, and the plug side guide and the socket side guide are each provided with a positioning portion that aligns tip end portions of the plug and the plug side guide to a predetermined position in an axial direction when the plug is inserted into the socket. The positioning portion includes a protrusion portion formed at the tip end portion of the plug side guide, and a groove formed in an opening portion of the socket side guide so as to allow the protrusion portion to enter the opening portion. According to such a configuration, since the tip end portions of the plug and the plug side guide are restricted in a normal direction by the positioning portion, the plug can be inserted and removed easily even when a central axis direction of the plug and a central axis direction of the socket are inclined.

### CITATION LIST

### Patent Literature

Patent Literature 1: JP2016-24952A

### SUMMARY OF INVENTION

### Technical Problem

However, in the connector guide mechanism disclosed in Patent Literature 1, since the protrusion portion at the plug side guide is constantly exposed, the protrusion portion may be scratched or a foreign matter may adhere to the protrusion portion, which may hinder fitting, or the foreign matter adhered to the protrusion portion may enter the socket.

The present invention has been made in view of the above circumstances, and an object of the present invention is to provide a connector fitting structure capable of protecting a protrusion portion for a fitting guide.

### Solution to Problem

In order to achieve the object described above, a connector fitting structure according to the present invention has the following features.

A connector fitting structure of a first connector and a second connector that are to be fitted and electrically connected to each other, in which
the first connector includes
   a first housing that accommodates a first connection terminal, and
   a guide groove that is provided in the first housing, and
the second connector includes
   a second housing that accommodates a second connection terminal,
   a guide protrusion portion that is provided at the second housing and is inserted into the guide groove, and
   a guide protection portion configured to be displaced between a covered position where the guide protection portion covers the guide protrusion portion and an exposed position where the guide protection portion does not cover the guide protrusion portion.

### Advantageous Effects of Invention

According to the connector fitting structure of the present invention, it is possible to protect the protrusion portion for the fitting guide.

The present invention has been briefly described above. Further, details of the present invention can be clarified by reading modes (hereinafter, referred to as “embodiments”) for carrying out the invention to be described below with reference to the accompanying drawings.

### BRIEF DESCRIPTION OF DRAWINGS

FIG. 1 is a perspective view showing an inlet serving as an example of a second connector and an inlet plug serving as an example of a first connector to be fitted in the inlet in a connector fitting structure according to a first embodiment of the present invention.

FIG. 2 is a perspective view showing a state in which a connector cover of the inlet shown in FIG. 1 is opened.

FIG. 3 is an exploded perspective view showing the inlet shown in FIG. 1.

FIG. 4 is a cross-sectional view showing a state in which the connector cover of the inlet shown in FIG. 1 is closed.

FIG. 5 is a perspective view showing a modification of the connector cover according to the first embodiment.

FIG. 6 is a perspective view showing an inlet serving as an example of a second connector in a connector fitting structure according to a second embodiment of the present invention.

FIG. 7 is a perspective view showing a state in which a connector cover and a pick-up rib cover of the inlet shown in FIG. 6 are opened.

FIG. 8 is an exploded perspective view showing the inlet shown in FIG. 6.

FIG. 9 is a cross-sectional view showing a state in which the connector cover and the pick-up rib cover of the inlet shown in FIG. 6 are closed.

FIG. 10 is a cross-sectional view showing a state in which the connector cover of the inlet shown in FIG. 6 is pivoted and brought into contact with the pick-up rib cover.

FIG. 11 is a cross-sectional view showing a state in which the pick-up rib cover is pivoted along with the pivoting of the connector cover of the inlet shown in FIG. 6.

FIG. 12 is a cross-sectional view showing a state in which the connector cover and the pick-up rib cover of the inlet shown in FIG. 6 are opened.

### DESCRIPTION OF EMBODIMENTS

A specific embodiment of the present invention will be described below with reference to the drawings.

### First Embodiment

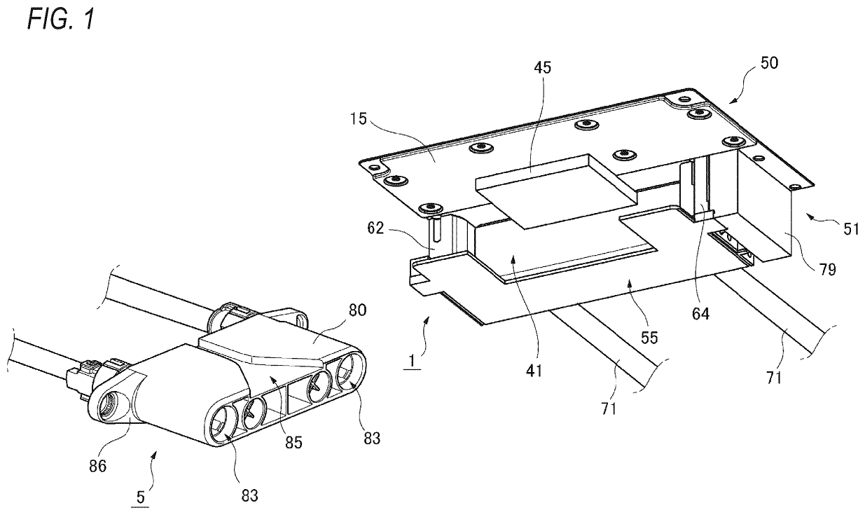

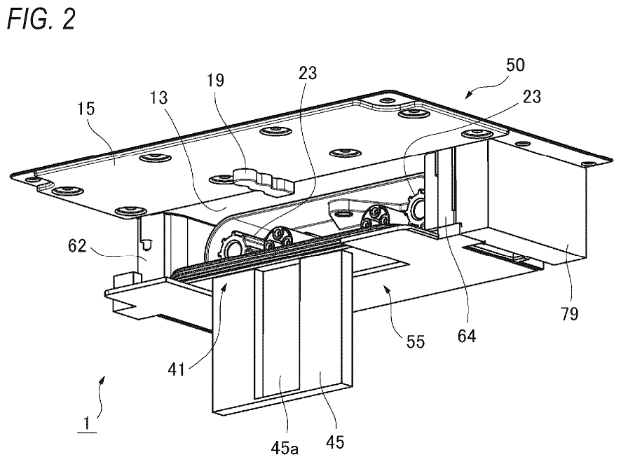

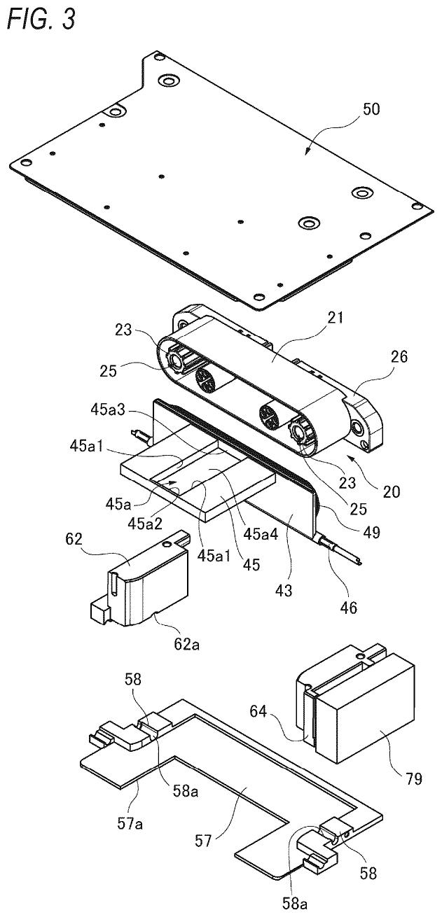

FIG. 1 is a perspective view showing an inlet 1 serving as an example of a second connector and an inlet plug 5 serving as an example of a first connector to be fitted in the inlet 1 in a connector fitting structure according to a first embodiment of the present invention. FIG. 2 is a perspective view showing a state in which a connector cover 41 of the inlet 1 shown in FIG. 1 is opened. FIG. 3 is an exploded perspective view showing the inlet 1 shown in FIG. 1.

As shown in FIGS. 1 to 3, the inlet 1 includes a housing 20 that accommodates a connection terminal (a second connection terminal), an outer case 51 that accommodates and holds the housing 20, a pick-up rib 19, and a connector cover 41 that is provided integrally with a pick-up rib cover portion 45a. The outer case 51 is an example of a second housing. The pick-up rib 19 is an example of a guide protrusion portion. The pick-up rib cover portion 45a is an example of a guide protection portion. The pick-up rib 19 is provided on the outer case 51 and is inserted into a fitting guide groove 85 serving as an example of a guide groove. The pick-up rib 19 is formed with a plurality of recessed portions in tip end sides of both side faces facing groove side faces of the fitting guide groove 85. The fitting guide groove 85 is provided in a plug housing 80 of the inlet plug 5. The pick-up rib cover portion 45a is provided integrally with the connector cover 41, covers the pick-up rib 19 when the connector cover 41 is at a closed position, and does not cover the pick-up rib 19 when the connector cover 41 is at an open position.

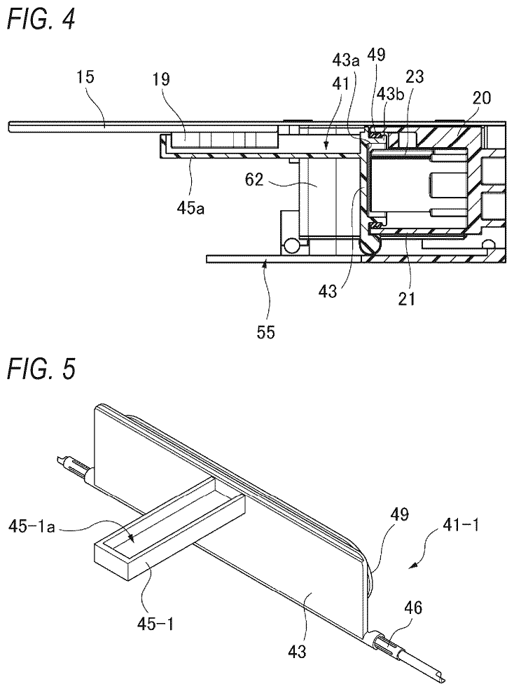

In the present specification, a front-rear direction is a direction along a connector fitting direction (a left-right direction in FIG. 4) of the housing 20, a side on which the plug housing 80 of the inlet plug 5 is fitted is referred to as front, an up-down direction is a direction (an up-down direction in FIG. 4) orthogonal to the connector fitting direction of the housing 20, and a top plate 50 side of the outer case 51 is referred to as upward.

The housing 20 of the inlet 1 is formed of an electrically insulating synthetic resin. The housing 20 includes a pair of terminal accommodating tube portions 23, 23 protruding toward the inlet plug 5, a hollow cylindrical hood portion 21 that covers the pair of terminal accommodating tube portions 23, 23, and a rear wall 26 on which the pair of terminal accommodating tube portions 23, 23 are provided and that closes a rear side of the hood portion 21.

A connection terminal to be connected to a terminal portion of a high-voltage cable 71 is accommodated in the terminal accommodating tube portion 23. The high-voltage cable to be connected to the connection terminal is drawn out from a rear opening of the terminal accommodating tube portion 23.

A front end of the terminal accommodating tube portion 23 is provided with a front opening 25 into which a connection terminal (a first connection terminal) of the inlet plug 5 is inserted. The front opening 25 is an example of an opening into an accommodating space of a connection terminal of the housing 20.

The outer case 51 is a flat case including a bottom portion 55, side wall members 62 and 64, and the top plate 50.

On the bottom portion 55, a bottom plate portion 57 and a pair of support portions 58, 58 are integrally formed. The bottom plate portion 57 is a flat plate having a size slightly smaller than that of the top plate 50. The bottom plate portion 57 has a rectangular opening 57a in a central portion of a front side, and has a U-shape in a plan view. The pair of support portions 58 are provided at left and right end portions on an upper face of the bottom plate portion 57, and support a pivoting shaft 46 of the connector cover 41 placed in recessed portions 58a that each have a substantially semi-cylinder shape on upper faces of the support portions 58.

The side wall members 62 and 64 are disposed on left and right sides of the housing 20, and serve as both side walls of the outer case 51. The side wall member 62 has a substantially cylindrical recessed portion 62a on a lower face, and the side wall member 64 has, on a lower face, a recessed portion (not shown) similar to the recessed portion 62a. One end portion (a left end portion) of the pivoting shaft 46 of the connector cover 41 is supported between the recessed portion 58a and the substantially semi-cylindrical recessed portion 62a provided on the lower face of the side wall member 62. Similarly, the other end portion (a right end portion) of the pivoting shaft 46 is supported between the recessed portion 58a and the recessed portion provided on the lower face of the side wall member 64. An actuator 79 that rotationally drives the pivoting shaft 46 is screwed to a right side face of the side wall member 64.

The top plate 50 is provided with an eave portion 15 that extends in front of an upper wall portion 13, the upper wall portion 13 defines a housing accommodating space together with the bottom plate portion 57 and the side wall members 62 and 64.

The pick-up rib 19 for guiding fitting of the plug housing 80 of the inlet plug 5 into the housing 20 accommodated in the outer case 51 extends along the connector fitting direction on a lower face of a central portion of the eave portion 15.

The pick-up rib 19 has a rounded tip end and has a substantially rectangular parallelepiped shape whose length in the connector fitting direction is longer than a length in the left-right direction. On a front side, a plurality of recessed portions are formed at a predetermined interval on left and right side faces of the pick-up rib 19. The predetermined interval is appropriately determined in consideration of a size of the pick-up rib 19, a size of the fitting guide groove 85, and the like.

The connector cover 41 includes a cover portion 43 that has a substantially rectangular plate shape and covers the front opening 25 of the terminal accommodating tube portion 23, the pivoting shaft 46 that is provided at a long side end portion of the cover portion 43, and a pick-up rib cover 45 that is provided at a long-side end portion of the cover portion 43 opposite to the pivoting shaft 46. The connector cover 41 is provided in a manner capable of being pivoted between a closed position where the cover portion 43 covers the front opening 25 of the terminal accommodating tube portion 23 and an open position where the cover portion 43 does not cover the front openings 25.

As shown in FIG. 4, a cylinder rib 43b conforming to a shape of an opening edge of the hood portion 21 is provided on a rear face 43a of the cover portion 43, and an elastic packing 49 is attached to an outer peripherical face of the cylinder rib 43b. The elastic packing 49 is formed of an elastic member such as sponge or rubber. When the connector cover 41 is closed, that is, when the connector cover 41 is at the closed position (see FIG. 4), the elastic packing 49 can elastically come into contact the hood portion 21 of the housing 20. Accordingly, it is possible to further reliably prevent dust and water from entering the front opening 25 of the housing 20.

The pick-up rib cover 45 is a plate-shaped member that is provided on a front side of the cover portion 43 and has the pick-up rib cover portion 45a, and the pick-up rib cover 45 is displaceable between a covered position where the pick-up rib cover 45 covers the pick-up rib 19 and an exposed position where the pick-up rib cover 45 does not cover the pick-up rib 19. The pick-up rib cover portion 45a can accommodate the pick-up rib 19 in a rectangular parallelepiped recessed portion that is provided at a central portion of the plate-shaped member in the left-right direction and extends along the connector fitting direction. That is, the pick-up rib cover portion 45a has a pair of side wall portions 45a1, 45a1, a front wall portion 45a2, a rear wall portion 45a3, and a bottom wall portion 45a4 that form the recessed portion.

For example, the pivoting shaft 46 is made of metal, and is formed integrally with the cover portion 43 and the pick-up rib cover 45 that are made of synthetic resin.

The inlet 1 is assembled as follows. The connector cover 41 is placed on the bottom plate portion 57 such that the pivoting shaft 46 is accommodated in the recessed portions 58a of the support portions 58, and the side wall members 62 and 64 are placed on an upper face of the bottom plate portion 57 such that the pivoting shaft 46 is accommodated in the recessed portion 62a. The top plate 50 is placed on upper faces of the side wall members 62 and 64. In this state, the side wall members 62 and 64 are respectively screwed to the pair of support portions 58 from a side, and the top plate 50 is screw-fixed to the side wall members 62 and 64 from above, thereby forming the outer case 51. The housing 20 that accommodates a connection terminal is inserted into the outer case 51 from a rear side, and the rear wall 26 of the housing 20 is screw-fixed to the side wall members 62 and 64 from a rear side. The assembled inlet 1 is attached to, for example, a vehicle body of an electric vehicle via the top plate 50.

The inlet plug 5 includes plug side connection terminals to be fitted to connection terminals of inlet 1, the plug housing 80 serving as an example of a first housing having a pair of terminal accommodating chambers 83, 83 for accommodating the plug side connection terminals, and a bracket 86 (see FIG. 1).

The plug housing 80 is formed of an electrically insulating synthetic resin. The bracket 86 is attached to the plug housing 80.

The fitting guide groove 85 is formed in an upper face of the plug housing 80. The fitting guide groove 85 has a tapered portion whose width increases toward the inlet 1. When the inlet plug 5 is fitted into the inlet 1, the fitting guide groove 85 can guide the plug housing 80 into the housing 20 by engaging the fitting guide groove 85 with the pick-up rib 19.

A connection terminal to be connected to a terminal portion of a plug side high-voltage cable (not shown) is accommodated in the terminal accommodating chamber 83. The plug side high-voltage cable to be connected to the connection terminal is drawn out from a rear opening of the terminal accommodating chamber 83.

Next, a fitting operation of the inlet 1 and the inlet plug 5 described above will be described with reference to FIG. 4. FIG. 4 shows a cross section along a fitting direction at a substantially central portion of the inlet 1 in the left-right direction.

As shown in FIG. 4, in a state in which the inlet 1 and the inlet plug 5 are not fitted to each other, the connector cover 41 is at a closed position where the cover portion 43 covers the front opening 25 (see FIG. 3) of the housing 20. Therefore, the inlet 1 is dust-proof, terminal-protected, and electric-shock-proof. As shown in FIG. 4, in a state in which the inlet 1 and the inlet plug 5 are not fitted to each other, the pick-up rib cover portion 45a is at a covered position where the pick-up rib cover portion 45a covers the pick-up rib 19. Therefore, the pick-up rib 19 of the inlet 1 is protected from scratches or foreign matter adhesion. Accordingly, fitting of the inlet 1 and the inlet plug 5 is prevented from being hindered. Since foreign matter adhesion to the pick-up rib 19 is prevented, a foreign matter adhered to the pick-up rib 19 is prevented from entering the inlet plug 5.

In order to start the insertion and fitting of the inlet plug 5 into the inlet 1 from the state shown in FIG. 4, the actuator 79 rotates the pivoting shaft 46 in the inlet 1, thereby pivoting the cover portion 43 of the connector cover 41 to the open position where the cover portion 43 does not cover the front opening 25. At this time, the pick-up rib cover portion 45a provided integrally with the cover portion 43 is pivoted at the same time with the pivoting of the cover portion 43, and is pivoted to an exposed position where the pick-up rib cover portion 45a does not cover the pick-up rib 19. When the connector cover 41 is opened in this manner, as shown in FIG. 2, the cover portion 43 is at the open position, and the pick-up rib cover portion 45a is at the exposed position in the inlet 1. In a state in which the connector cover 41 is opened, both left and right sides of the cover portion 43 come into contact with left and right sides of the opening 57a of the bottom plate portion 57, and the pick-up rib cover 45 extends downward through the opening 57a. The connector cover 41 is preferably opened immediately before the insertion and fitting of the inlet plug 5 into the inlet 1 from the viewpoint of protecting the pick-up rib 19, dust-proof, terminal protection, and electric-shock-proof.

As shown in FIG. 2, the inlet plug 5 is moved toward the inlet 1 in a state in which the connector cover 41 is opened, and the insertion and fitting of the plug housing 80 into the outer case 51 are started. In a state immediately after the start of the fitting, the upper face of the plug housing 80 comes into contact with a lower face of the top plate 50 of the inlet 1, and a tip end of the pick-up rib 19 is inserted into the fitting guide groove 85.

From this state, when the inlet plug 5 is inserted deeply to further advance to a rear side of the inlet 1, the tip end of the pick-up rib 19 is guided into the fitting guide groove 85, and a front end of the plug housing 80 abuts against the rear wall 26 of the housing 20. In this state, a connection terminal of the inlet plug 5 is fitted and connected to a connection terminal of the inlet 1. Accordingly, the high-voltage cable on the inlet 1 side and the plug side high-voltage cable are electrically connected and used. After use, the inlet plug 5 is detached from the inlet 1, and the actuator 79 rotates the pivoting shaft 46 in a reversed direction, thereby bringing the connector cover 41 into the closed state shown in FIGS. 1 and 4. In this state, since the cover portion 43 is at the closed position, the inside of the housing 20 is protected.

According to the inlet 1, since the connector cover 41 has the pick-up rib cover portion 45a, the pick-up rib 19 is not exposed by being covered with the pick-up rib cover portion 45a in a state in which the inlet plug 5 is not inserted and fitted into the inlet 1, and thus the pick-up rib 19 is protected from scratches and foreign matter adhesion. Therefore, fitting of the inlet 1 and the inlet plug 5 is prevented from being hindered, and a foreign matter adhered to the pick-up rib 19 is prevented from entering the inlet plug 5.

### Modifications

The inlet 1 according to the first embodiment may include a connector cover 41-1 shown in FIG. 5 instead of the connector cover 41. The connector cover 41-1 shown in FIG. 5 has a pick-up rib cover 45-1 having a rectangular parallelepiped shape, instead of the plate-shaped pick-up rib cover 45 shown in FIG. 1. The pick-up rib cover 45-1 has a pick-up rib cover portion 45-1a having a narrower width in the left-right direction than the pick-up rib cover portion 45a. Since the pick-up rib cover 45-1 of the connector cover 41-1 shown in FIG. 5 is formed in a more compact manner than the pick-up rib cover 45, a load on the actuator 79 for rotationally driving the pivoting shaft 46 can be reduced.

### Second Embodiment

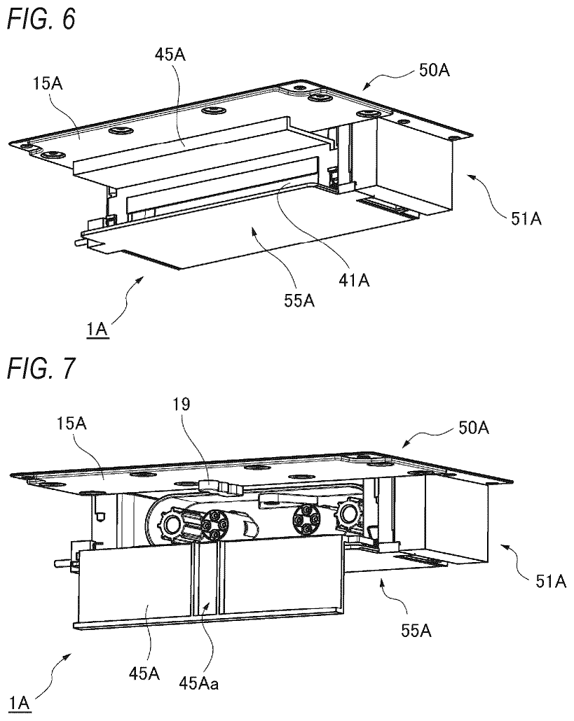

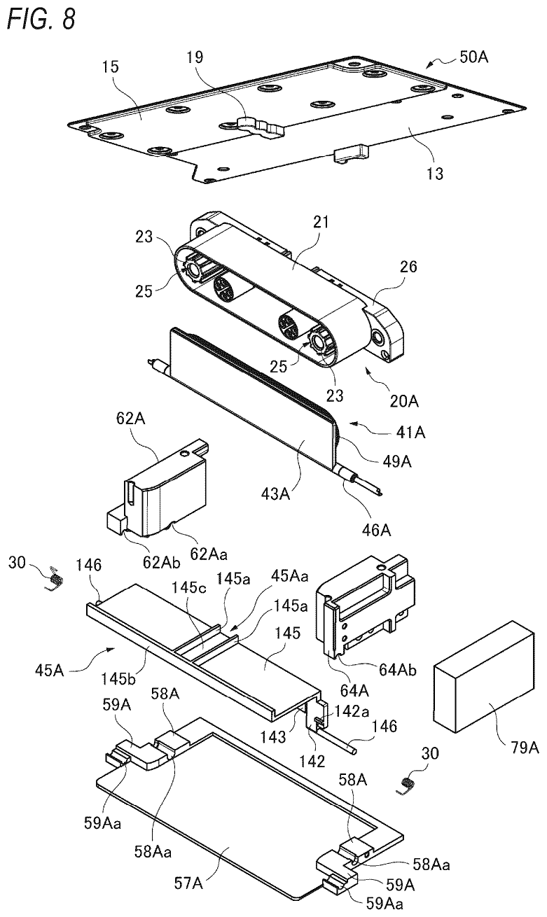

FIG. 6 is a perspective view showing an inlet 1A serving as an example of a second connector in the connector fitting structure according to a second embodiment of the present invention, and showing a state in which a connector cover 41A and a pick-up rib cover 45A of the inlet 1A are closed. FIG. 7 is a perspective view showing a state in which the connector cover 41A and the pick-up rib cover 45A of the inlet 1A shown in FIG. 6 are opened. FIG. 8 is an exploded perspective view showing the inlet 1A shown in FIG. 6. The inlet plug 5 shown in FIG. 1 is inserted and fitted into the inlet 1A according to the second embodiment. In the present embodiment, the same or equivalent members as those in the first embodiment are denoted by the same or equivalent reference numerals.

The inlet 1A according to the second embodiment is mainly different from the inlet 1 according to the first embodiment in that the connector cover 41A and the pick-up rib cover 45A are provided instead of the connector cover 41.

As shown in FIGS. 6 to 8, the inlet 1A according to the second embodiment includes a housing 20A that accommodates a connection terminal (a second connection terminal), an outer case 51A that accommodates and holds the housing 20A, the pick-up rib 19, a pick-up rib cover portion 45Aa, and the connector cover 41A. The outer case 51A is an example of a second housing. The pick-up rib 19 is an example of a guide protrusion portion. The pick-up rib cover portion 45Aa is an example of a guide protection portion. The pick-up rib 19 is provided at the outer case 51A and is inserted into the fitting guide groove 85 (see FIG. 1) serving as an example of a guide groove. The pick-up rib cover portion 45Aa is provided on the pick-up rib cover 45A separate from the connector cover 41A. As the connector cover 41A is pivoted from a closed position where the connector cover 41A covers the front opening 25 to an open position where the connector cover 41A does not cover the front opening 25, the pick-up rib cover 45A biased by the connector cover 41A is pivoted. The pick-up rib cover portion 45Aa is displaced from a covered position where the pick-up rib cover portion 45Aa covers the pick-up rib 19 to an exposed position where the pick-up rib cover portion 45Aa does not cover the pick-up rib 19 by pivoting the pick-up rib cover 45A biased by the connector cover 41A.

The housing 20A of the inlet 1A has the same configuration as the housing 20 of the inlet 1.

The outer case 51A is a flat case including a bottom portion 55A, side wall members 62A and 64A, and a top plate 50A.

The bottom portion 55A is integrally formed with a bottom plate portion 57A, a pair of support portions 58A, 58A, and a pair of support portions 59A, 59A. The bottom plate portion 57A is a rectangular flat plate having a size slightly smaller than that of the top plate 50A. The pair of support portions 58A, 58A are provided at left and right end portions on an upper face of the bottom plate portion 57A, and support a pivoting shaft 46A of the connector cover 41 placed in recessed portions 58Aa that each have a substantially semi-cylinder shape on upper faces of the support portions 58A, 58A. The pair of support portions 59A, 59A are respectively provided on left and right sides of the bottom plate portion 57A, and recessed portions 59Aa that each have a semi-cylinder shape are provided on upper faces of the support portions 59A, 59A. The support portions 59A support pivoting shafts 146 of the pick-up rib cover 45A placed in the recessed portions 59Aa.

The side wall members 62A and 64A are disposed on left and right sides of the housing 20A, and serve as both side walls of the outer case 51A. The side wall member 62A has substantially cylindrical recessed portions 62Aa and 62Ab on a lower face. The side wall member 64A has, on a lower face, a recessed portion similar to the recessed portion 62a and a recessed portion 64Ab similar to the recessed portion 62Ab. One end portion (a left end portion) of the pivoting shaft 46A of the connector cover 41A is supported between the recessed portion 58Aa and the substantially semi-cylindrical recessed portion 62Aa provided in the lower face of the side wall member 62A. Similarly, the other end portion (a right end portion) of the pivoting shaft 46A is supported between the recessed portion 58Aa and the recessed portion provided in the lower face of the side wall member 64A. Both end portions of the pivoting shafts 146 of the pick-up rib cover 45A are respectively supported between the pair of recessed portions 59Aa and 59Aa and the recessed portions 62Ab and 64Ab provided in the lower faces of the side wall members 62A and 64A. An actuator 79A that rotationally drives the pivoting shaft 46A is screw-fixed to a right side face of the side wall member 64A.

The top plate 50A has the same configuration as the top plate 50.

The connector cover 41A includes a substantially rectangular plate-shaped cover portion 43A that covers the front opening 25 of the terminal accommodating tube portion 23 of the housing 20A, and the pivoting shaft 46A that is provided at a long-side end portion of the cover portion 43A. The connector cover 41A is provided in a manner capable of being pivoted between a closed position where the cover portion 43A covers the front opening 25 of the terminal accommodating tube portion 23 and an open position where the cover portion 43A does not cover the front opening 25.

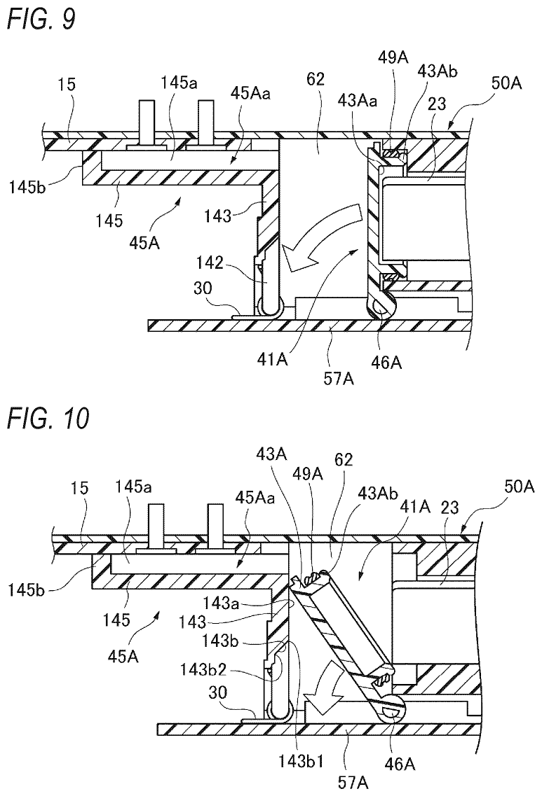

As shown in FIG. 9, a cylinder rib 43Ab conforming to a shape of an opening edge of the hood portion 21 is provided on a rear face 43Aa of the cover portion 43A, and an elastic packing 49A is attached to an outer peripherical face of the cylinder rib 43Ab. The elastic packing 49A is formed of an elastic member such as sponge or rubber. When the connector cover 41A is closed, that is, when the connector cover 41A is at the closed position (see FIG. 9), the elastic packing 49A can elastically come into contact the hood portion 21 of the housing 20A. Accordingly, it is possible to further reliably prevent dust and water from entering the front opening 25 of the housing 20A.

The pick-up rib cover 45A is a substantially L-shaped member in a side view that is parallel to the connector cover 41A on a front face side of the connector cover 41A and has the pick-up rib cover portion 45Aa. The pick-up rib cover 45A is provided in a manner of being displaceable between a covered position where the pick-up rib cover portion 45Aa covers the pick-up rib 19 and an exposed position where the pick-up rib cover portion 45Aa does not cover the pick-up rib 19. The pick-up rib cover 45A includes a first plate-shaped member 145, a second plate-shaped member 143 coupled to the first plate-shaped member 145, a pair of support portions 142, 142, and a pair of pivoting shafts 146, 146.

As shown in FIG. 8, the first plate-shaped member 145 is provided with a pair of rectangular ribs 145a, 145a extending in the connector fitting direction in a central portion in the left-right direction and a front rib 145b standing on a front long-side end portion in the left-right direction. The first plate-shaped member 145 can accommodate the pick-up rib 19 in a recessed portion formed by the pair of rectangular ribs 145a, 145a and the front rib 145b. That is, the pick-up rib cover portion 45Aa is formed by the pair of rectangular ribs 145a, 145a, the front rib 145b, and a bottom portion 145c. The bottom portion 145c is a portion of the first plate-shaped member 145 between the pair of rectangular ribs 145a, 145a. The second plate-shaped member 143 extends in a direction orthogonal to the first plate-shaped member 145 from a long-side end portion of the first plate-shaped member 145 on a connector cover 41A side. The pair of support portions 142, 142 respectively extend along the second plate-shaped member 143 from left and right end portions of the second plate-shaped member 143, and support the pivoting shafts 146 provided at tip end portions of the support portions 142, 142. The pair of support portions 142, 142 each have a protrusion portion 142a that comes into contact with an upper face of the bottom plate portion 57A in a state in which the pick-up rib cover 45A is opened. The pair of pivoting shafts 146, 146 extend outward from the respective support portions 142, 142 and substantially parallel to the pivoting shaft 46A of the connector cover 41A. The second plate-shaped member 143 functions as a contact portion to be brought into contact with the cover portion 43A of the connector cover 41A.

As shown in FIG. 9, the second plate-shaped member 143 has a first slide face 143a and a second slide face 143b continuous with the first slide face 143a. The first slide face 143a extends in one direction toward the pivoting shaft 146, and the second slide face 143b extends inclined relative to the one direction. The second slide face 143b has a first end portion 143b1 coupled to the first slide face 143a and a second end portion 143b2 opposite to the first end portion 143b1. As shown in FIG. 10, in a state in which the pick-up rib cover portion 45Aa is at the covered position, a distance between the first end portion 143b1 and the pivoting shaft 46A is shorter than or equal to a distance between the second end portion 143b2 and the pivoting shaft 46A. The second slide face 143b is inclined relative to the first slide face 143a of the second plate-shaped member 143 such that the distance between the first end portion 143b1 and the pivoting shaft 46A is shorter than or equal to the distance between the second end portion 143b2 and the pivoting shaft 46A. According to such a configuration, the cover portion 43A can come into contact with the second plate-shaped member 143 without being caught, and the pick-up rib cover 45A can be smoothly pivoted.

The inlet 1A is assembled as follows. The connector cover 41A is placed on the bottom plate portion 57A such that both end portions of the pivoting shaft 46A are accommodated in the respective recessed portions 58Aa of the support portions 58A. Coil springs 32 are inserted into the pivoting shafts 146 from the outside and the pick-up rib cover 45A is placed on the bottom plate portion 57A such that outer end portions of the pivoting shafts 146 are accommodated in the respective recessed portions 59Aa of the support portions 59A. One end of the coil spring 32 is locked to the support portion 142, and the other end of the coil spring 32 is locked to the bottom plate portion 57A. The coil spring 32 biases the pick-up rib cover 45A to bring the pick-up rib cover 45A to the closed state. The side wall members 62A and 64A are placed on the upper face of the bottom plate portion 57 such that both end portions of the pivoting shaft 46A are respectively accommodated in the recessed portions 62Aa and the recessed portion provided in the lower face of the side wall member 64A, the left pivoting shaft 146 is accommodated in the recessed portion 62Ab, and the right pivoting shaft 146 is accommodated in the recessed portion 64Ab. The top plate 50A is placed on upper faces of the side wall members 62A and 64A. In this state, the side wall members 62A and 64A are respectively screw-fixed to the pair of support portions 58A from a side, and the top plate 50A is screw-fixed to the side wall members 62A and 64A from above, thereby forming the outer case 51A. The housing 20A that accommodates a connection terminal is inserted into the outer case 51A from a rear side, and the rear wall 26 of the housing 20A is screw-fixed to the side wall members 62A and 64A from a rear side. The assembled inlet 1A is attached to, for example, a vehicle body of an electric vehicle via the top plate 50A.

Next, a fitting operation of the inlet 1A and the inlet plug 5 shown in FIG. 1 will be described with reference to FIGS. 9 to 12. FIGS. 9 to 12 show a cross section along a fitting direction at a substantially central portion of the inlet 1A in the left-right direction.

As shown in FIG. 9, in a state in which the inlet 1A and the inlet plug 5 are not fitted to each other, the connector cover 41A is at a closed position where the cover portion 43A covers the front opening 25 (see FIG. 8) of the housing 20A. Therefore, the inlet 1A is dust-proof, terminal-protected, and electric-shock-proof. As shown in FIG. 9, in a state in which the inlet 1A and the inlet plug 5 are not fitted to each other, the pick-up rib cover portion 45Aa is at a covered position where the pick-up rib cover portion 45Aa covers the pick-up rib 19. Therefore, the pick-up rib 19 of the inlet 1A is protected from scratches or foreign matter adhesion. Accordingly, fitting of the inlet 1A and the inlet plug 5 is prevented from being hindered. Since foreign matter adhesion to the pick-up rib 19 is prevented, a foreign matter adhered to the pick-up rib 19 is prevented from entering the inlet plug 5.

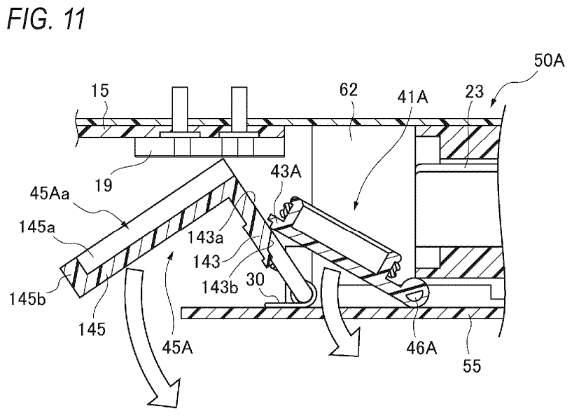

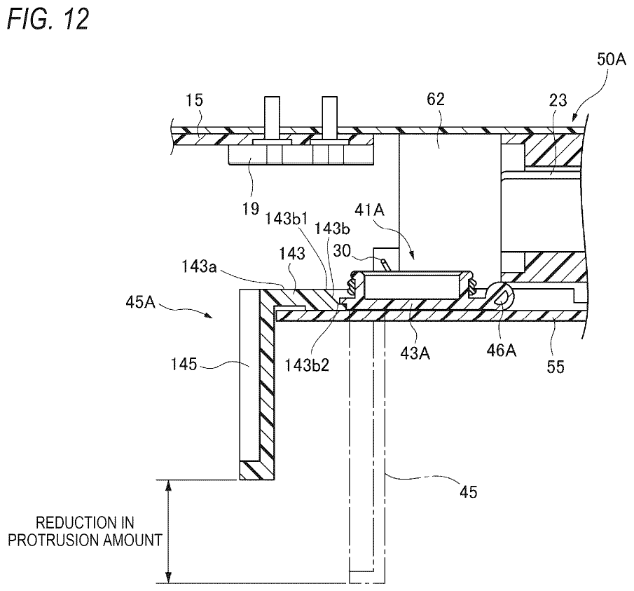

In order to start the insertion and fitting of the inlet plug 5 into the inlet 1 from the state shown in FIG. 9, the connector cover 41A and the pick-up rib cover 45A are opened as follows. First, in the inlet 1A, when the actuator 79A rotates the pivoting shaft 46A, the cover portion 43A of the connector cover 41A is pivoted in a direction of an arrow shown in FIG. 9. When the cover portion 43A is pivoted, as shown in FIG. 10, an upper edge portion of the cover portion 43A comes into contact with the second plate-shaped member 143 of the pick-up rib cover 45A. When the connector cover 41A is further pivoted, the cover portion 43A biases while sliding on the first slide face 143a of the second plate-shaped member 143, and the pick-up rib cover 45A is pivoted as shown in FIG. 11. When the connector cover 41A is further pivoted, the cover portion 43A slides on the second slide face 143b of the second plate-shaped member 143, and the connector cover 41A and the pick-up rib cover 45A are opened as shown in FIG. 12.

In the open state shown in FIG. 12, the connector cover 41A is pivoted to an open position where the connector cover 41A does not cover the front opening 25. At this time, the pick-up rib cover portion 45Aa is pivoted to an exposed position where the pick-up rib cover portion 45Aa does not cover the pick-up rib 19 along with the pivoting of the cover portion 43. When the connector cover 41A and the pick-up rib cover 45A are opened in this manner, the cover portion 43A is at the open position and the pick-up rib cover portion 45Aa is at the exposed position in the inlet 1, as shown in FIG. 12. In a state in which the connector cover 41A is opened, a front side of the cover portion 43A comes into contact with the upper face of the bottom plate portion 57A, and the protrusion portion 142a of the pick-up rib cover 45A comes into contact with the upper face of the bottom plate portion 57A. The connector cover 41A and the pick-up rib cover 45A are preferably opened immediately before the insertion and fitting of the inlet plug 5 into the inlet 1A, from the viewpoint of protecting the pick-up rib 19, dust-proof, terminal protection, and electric-shock-proof.

In FIG. 12, the pick-up rib cover 45 provided integrally with the connector cover 41 according to the first embodiment is indicated by a chain line. In the inlet 1A according to the second embodiment, since the connector cover 41A and the pick-up rib cover 45A are formed separately, it is possible to reduce a protrusion amount of the pick-up rib cover 45A to a lower side of the inlet 1A in the open state.

As shown in FIG. 12, the inlet plug 5 is moved toward the inlet 1A in a state in which the connector cover 41A and the pick-up rib cover 45A are opened, and the insertion and fitting of the plug housing 80 into the outer case 51 are started. In a state immediately after the start of the fitting, an upper face of the plug housing 80 comes into contact with a lower face of the top plate 50A of the inlet 1A, and a tip end of the pick-up rib 19 is inserted into the fitting guide groove 85.

From this state, when the inlet plug 5 is inserted deeply to further advance to a rear side of the inlet 1A, the tip end of the pick-up rib 19 is guided into the fitting guide groove 85, and a front end of the plug housing 80 abuts against the rear wall 26 of the housing 20A. In this state, a connection terminal of the inlet plug 5 is fitted and connected to a connection terminal of the inlet 1A. Accordingly, the high-voltage cable on the inlet 1 side and the plug side high-voltage cable are electrically connected and used. After use, when the inlet plug 5 is detached from the inlet 1A, the pick-up rib cover 45A is closed by a biasing force of the coil spring 32. Then, the actuator 79A rotates the pivoting shaft 46 in a reversed direction, thereby bringing the connector cover 41A into the closed state (see FIG. 9). In this state, since the cover portion 43A is at the closed position, the inside of the housing 20A is protected.

According to the inlet 1A, since the pick-up rib 19 is not exposed by being covered with the pick-up rib cover portion 45Aa in a state in which the inlet plug 5 is not inserted and fitted into the inlet 1, the pick-up rib 19 is protected from scratches and foreign matter adhesion. Therefore, fitting of the inlet 1A and the inlet plug 5 is prevented from being hindered, and a foreign matter adhered to the pick-up rib 19 is prevented from entering the inlet plug 5.

Further, in the inlet 1A, since the connector cover 41A and the pick-up rib cover 45A are formed separately, it is possible to reduce a protrusion amount of the pick-up rib cover 45A to a lower side of the inlet 1A in the open state. Therefore, the inlet 1A can be made compact.

The present invention is not limited to the above embodiments, and can be appropriately modified, improved, and the like. In addition, materials, shapes, sizes, numbers, arrangement positions, and the like of components in the embodiments described above are freely selected and are not limited as long as the present invention can be implemented.

For example, although an inlet used in an electric vehicle or the like is used as a connector in the embodiments described above, the connector according to the present invention is not limited thereto, and can be applied to various connectors based on the spirit of the present invention.

Here, features of the connector fitting structure according to the embodiments of the present invention described above are briefly summarized and listed in the following [1] to [7].

[1] A connector fitting structure of a first connector (the inlet plug 5) and a second connector (the inlet 1, 1A) that are to be fitted and electrically connected to each other, in which
the first connector (the inlet plug 5) includes
   a first housing (the plug housing 80) that accommodates a first connection terminal, and
   a guide groove (the fitting guide groove 85) that is provided in the first housing, and
the second connector (the inlet 1, 1A) includes
   a second housing (the outer case 51, 51A) that accommodates a second connection terminal,
   a guide protrusion portion (the pick-up rib 19) that is provided at the second housing and is inserted into the guide groove, and
   a guide protection portion (the pick-up rib cover portion 45a, 45Aa) configured to be displaced between a covered position where the guide protection portion covers the guide protrusion portion and an exposed position where the guide protection portion does not cover the guide protrusion portion.

According to the connector fitting structure having the configuration of the above [1], in a state in which the first connector and the second connector are not fitted to each other, since the guide protrusion portion is not exposed by being covered by the guide protection portion, the guide protrusion portion is protected from scratches or foreign matter adhesion. Accordingly, fitting of the first connector and the second connector can be prevented from being hindered, and a foreign matter adhered to the guide protrusion portion can be prevented from entering the first connector.

[2] The connector fitting structure according to the above [1], in which
the second connector (the inlet 1, 1A) includes a connector cover (41, 41A) configured to be pivoted between a closed position where the connector cover covers an opening (the front opening 25) into an accommodating space of the second connection terminal of the second housing and an open position where the connector cover does not cover the opening.

According to the connector fitting structure of having the configuration of the above [2], in a state in which the first connector and the second connector are not fitted to each other, since the connector cover is at the closed position and covers the opening, the connector fitting structure is dust-proof, terminal-protected, and electric-shock-proof.

[3] The connector fitting structure according to the above [2], in which
the guide protection portion (the pick-up rib cover portion 45a) is provided integrally with the connector cover, covers the guide protrusion portion when the connector cover (41) is at the closed position, and does not cover the guide protrusion portion when the connector cover is at the open position.

According to the connector fitting structure having the configuration of the above [3], since the guide protection portion is provided integrally with the connector cover, protection of the guide protrusion portion by the guide protection portion, and dust-proof, terminal protection, and electric-shock-proof by the connector cover can be achieved with a simple configuration.

[4] The connector fitting structure according to the above [2], in which
the guide protection portion (the pick-up rib cover portion 45Aa) is provided at a guide cover (the pick-up rib cover 45A) separate from the connector cover (41A), and as the connector cover (41A) is pivoted from the closed position to the open position, the guide cover biased by the connector cover is pivoted, and the guide protection portion is displaced from the covered position to the exposed position.

According to the connector fitting structure having the configuration of the above [4], as compared with a case where the connector cover and the guide cover are integrally provided, a protrusion amount of the guide cover from the second connector in a state in which the connector cover and the guide cover are opened can be reduced.

[5] The connector fitting structure according to [4], in which
the connector cover (41A) includes a cover portion (43A) that covers the opening of the second housing and a connector cover pivoting shaft (the pivoting shaft 46A) that is provided at an edge portion of the cover portion,
the guide cover (the pick-up rib cover 45A) includes
   a contact portion (the second plate-shaped member 143) that comes into contact with the cover portion of the connector cover, and
   a guide cover pivoting shaft (the pivoting shaft 146) that is provided at an edge portion of the contact portion and extends substantially parallel to the connector cover pivoting shaft,
the guide protection portion (the pick-up rib cover portion 45Aa) is provided integrally with the contact portion, and
a direction in which the guide protection portion is pivoted from the covered position to the exposed position is substantially the same as a direction in which the connector cover is pivoted from the closed position to the open position.

According to the connector fitting structure having the configuration of the above [5], the connector cover and the guide protection portion are pivoted to open in substantially the same direction from a state in which the connector cover is at the closed position and the guide protection portion is at the covered position, and the first connector and the second connector can be fitted to each other.

[6] The connector fitting structure according to the above [5], in which
the connector cover is biased by sliding an edge portion opposite to the edge portion of the cover portion on the contact portion of the guide cover,
the contact portion (the second plate-shaped member 143) of the guide cover (the pick-up rib cover 45A) has a first slide face (143a) and a second slide face (143b) continuous with the first slide face, the first slide face (143a) extends in one direction toward the guide cover pivoting shaft, the second slide face (143b) extends inclined relative to the one direction, and in a state in which the guide protection portion (the pick-up rib cover portion 45Aa) is at the covered position, a distance between the connector cover pivoting shaft (the pivoting shaft 46A) and a first end portion (143b1) of the second slide face that is coupled to the first slide face is shorter than or equal to a distance between the connector cover pivoting shaft and a second end portion (143b2) of the second slide face that is opposite to the first end portion. According to the connector fitting structure having the configuration of the above [6], the second slide face of the contact portion is inclined relative to the first slide face such that the distance between the first end portion and the connector cover pivoting shaft is shorter or equal to the distance between the second end portion and the connector cover pivoting shaft. According to such a configuration, the connector cover comes into contact with the contact portion without being caught, and the guide cover can be smoothly pivoted.

[7] The connector fitting structure according to the above [5] or [6], in which
the second housing (the outer case 51A) has a first face (a lower face of the eave portion 15A) and a second face (an upper face of the bottom plate portion 57A) that face each other,
on a first face side of the second housing, the guide protrusion portion (a guide rib F: the pick-up rib 19) protrudes toward a second face side, extends along a fitting direction of the first connector and the second connector, and
the guide cover pivoting shaft of the guide cover is supported on the second face side of the second housing.

According to the connector fitting structure having the configuration of the above [7], the guide cover can protect the guide protrusion portion by being pivoted around the pivoting shaft supported on the second face side.

Note that the present application is based on a Japanese Patent Application (No. 2022-029802) filed on Feb. 28, 2022, the contents of which are incorporated herein by reference.

### INDUSTRIAL APPLICABILITY

The connector fitting structure according to the present invention has an effect of protecting a protrusion portion of a fitting guide, and is applicable to various connectors, such as an inlet used in an electric vehicle or the like.

### REFERENCE SIGNS LIST

1, 1A: inlet (second connector)
5: inlet plug (first connector)
19: pick-up rib
23: terminal accommodating tube portion
25: front opening
41, 41-1, 41A: connector cover
43, 43A: cover portion
45, 45-1: pick-up rib cover
45a, 45Aa, 45-1a: pick-up rib cover portion
46, 46A: pivoting shaft (connector cover pivoting shaft)
51, 51A: outer case (second housing)
80: plug housing (first housing)
85: fitting guide groove (guide groove)
143: second plate-shaped member
143a: first slide face
143b: second slide face
143b1: first end portion
143b2: second end portion

1. A connector fitting structure of a first connector and a second connector that are to be fitted and electrically connected to each other, wherein:
the first connector includes:
a first housing that accommodates a first connection terminal; and
a guide groove that is provided in the first housing;
the second connector includes:
a second housing that accommodates a second connection terminal;
a guide protrusion portion that is provided at the second housing and is inserted into the guide groove;
a guide protection portion configured to be displaced between a covered position where the guide protection portion covers the guide protrusion portion and an exposed position where the guide protection portion does not cover the guide protrusion portion; and
a connector cover configured to be pivoted between a closed position where the connector cover covers an opening into an accommodating space of the second connection terminal of the second housing and an open position where the connector cover does not cover the opening;
the guide protection portion is provided at a guide cover separate from the connector cover; and
as the connector cover is pivoted from the closed position to the open position, the guide cover biased by the connector cover is pivoted, and the guide protection portion is displaced from the covered position to the exposed position.

2. The connector fitting structure according to claim 1, wherein:
the connector cover includes a cover portion that covers the opening of the second housing and a connector cover pivoting shaft that is provided at an edge portion of the cover portion;
the guide cover includes:
a contact portion that comes into contact with the cover portion of the connector cover; and
a guide cover pivoting shaft that is provided at an edge portion of the contact portion and extends substantially parallel to the connector cover pivoting shaft;
the guide protection portion is provided integrally with the contact portion; and
a direction in which the guide protection portion is pivoted from the covered position to the exposed position is substantially the same as a direction in which the connector cover is pivoted from the closed position to the open position.

3. The connector fitting structure according to claim 2, wherein:
the connector cover is biased by sliding an edge portion opposite to the edge portion of the cover portion on the contact portion of the guide cover; and
the contact portion of the guide cover has a first slide face and a second slide face continuous with the first slide face, the first slide face extends in one direction toward the guide cover pivoting shaft, the second slide face extends inclined relative to the one direction, and in a state in which the guide protection portion is at the covered position, a distance between the connector cover pivoting shaft and a first end portion of the second slide face that is coupled to the first slide face is shorter than or equal to a distance between the connector cover pivoting shaft and a second end portion of the second slide face that is opposite to the first end portion.

4. The connector fitting structure according to claim 2, wherein:
the second housing has a first face and a second face that face each other;
on a first face side of the second housing, the guide protrusion portion protrudes toward a second face side, extends along a fitting direction of the first connector and the second connector; and
the guide cover pivoting shaft of the guide cover is supported on the second face side of the second housing.
